(19) United States
(12) Patent Application Publication
(10) Pub. No.: US 2024/0418270 A1
(43) Pub. Date: Dec. 19, 2024

(54) OPTIMIZED GATE VALVE ASSEMBLY

(71) Applicant: Celeros Flow Technology, LLC, Charlotte, NC (US)

(72) Inventors: Raul ALMAZAN, The Woodlands, TX (US); Brijesh GAJJAR, Tomball, TX (US)

(21) Appl. No.: 18/703,061

(22) PCT Filed: Oct. 13, 2022
(86) PCT No.: PCT/US2022/078067

§ 371 Date: Apr. 19, 2024

Related U.S. Application Data
(60) Provisional application No. 63/257,793, filed on Oct. 20, 2021.

(51) Int. Cl. F16K 3/02; F16K 27/10

(52) U.S. Cl. CPC F16K 3/0227; F16K 3/0254; F16K 27/10

(57) ABSTRACT

An optimized gate valve having a box-shaped valve body is provided. The valve body (20) includes spaced apart side plates (22, 23) and spaced apart end plates. The valve body includes an internal fluid passage and an internal gate chamber extending transverse to the internal fluid passage. A slab gate is provided in the internal gate chamber and is operable to move within the internal gate chamber between an open position allowing fluid flow through the fluid passage and a closed position obstructing fluid flow through the internal fluid passage. The design optimization requires less welding, reduces the thickness of the valve body walls, uses reinforcement ribs (50) having an optimal position and shape, and uses fins (48) to help the pipe connection contain the internal pressure of the valve.

### FIELD OF THE INVENTION

The present invention generally relates to a gate valve assembly, and more particularly, to an optimized floating slab gate valve assembly configured to maintain structural integrity while controlling pressurized fluid flow.

### BACKGROUND

A gate valve is typically used to control fluid flow through a conduit by lifting a gate out of the path of the fluid. Conventional gate valves include a valve body having a fluid flow passageway, a gate chamber perpendicular to the fluid flow passageway, and a gate slidably disposed in the gate chamber. A cupola is typically secured to the top of the valve body in some sizes and closes off the gate chamber from the external environment. The gate is reciprocally moveable within the gate chamber between a closed position in which the gate extends across the fluid flow passageway and obstructs the flow of fluid through the valve, and an open position in which the gate does not obstruct the flow of fluid through the valve. A stem extending through the cupola and into the gate chamber is coupled to the gate and used to control the position of the gate via an operator.

A valve seat is commonly disposed in the fluid flow passageway and extends between the valve body and the gate to allow fluid flow through the valve while restricting fluid communication between the gate chamber and the fluid flow passageway. For instance, when the valve is closed, the valve seat functions to isolate the gate chamber from the fluid flow passageway. Moreover, the fluid in the passageway upstream of the closed gate is prevented from reaching the gate chamber in order to minimize fluids in the closed valve upstream of the gate from reaching the gate chamber.

Conventional fabricated gate valves are often expensive to manufacture since they require a comparatively large amount of raw material and welding for the fabrication process. Additionally, conventional gate valves often require special machinery to produce the various components. As a result, the manufacturing process is often very labor intensive and time consuming. Moreover, many conventional gate valves have the further disadvantage of including expendable parts which are costly to manufacture, and thus expensive to replace if they fail. Additionally, a gate valve body not only has to retain the pressure of the fluid flowing through the valve, but it must also be strong enough to carry the external loads applied to the body by the fluid line.

For instance, such line loads include those loads which are externally produced upon the valve, i.e., the load caused by thermal expansion of the connecting piping, the load caused by mechanical loads or shocks on the connecting piping, loads caused by torsion, etc. Gate loads, on the other hand, are those loads produced by differential pressure across the closed gate. To help carry these loads, a conventional gate valve body may include a plurality of reinforcing members attached to the region of the wall plates via welding, thus forming an outside shell for the valve body. However, the particular welding construction of such reinforcement members to the valve body in conventional gate valve assemblies disadvantageously increases manufacturing time and also increases associated labor costs. Accordingly, there remains a need in the art for a gate valve assembly that is both easier and less time consuming to manufacture than conventional gate valve assemblies, as well as being less expensive to manufacture.

The present invention solves these aforementioned problems by providing a new and improved gate valve assembly that is materially less costly and less time consuming to manufacture. The present invention furthermore possesses many other advantages, and has other purposes, including enhanced durability which reduces the need for maintenance or replacement, and thus also reduces the risk of service personnel being exposed to pressurized fluid within the valve. Other advantages and purposes may be further apparent from consideration of the present specification and the accompanying drawings.

### SUMMARY

The foregoing needs are met, to a great extent, by the present invention of a gate valve assembly comprising a valve body including a first side plate, a second side plate, a first end plate, and a second end plate, the first side plate being spaced apart from the second side plate and the first end plate being spaced apart from the second end plate to define an internal fluid passage and an internal gate chamber extending transverse to the internal fluid passage; a slab gate disposed in the internal gate chamber, the slab gate operable to move within the internal gate chamber between an open position allowing fluid flow through the fluid passage and a closed position obstructing fluid flow through the internal fluid passage; a bonnet removably attached to an upper end of the valve body; a first fluid conduit connected to the first side plate and a second fluid conduit connected to the second side plate, the first fluid conduit defining a first fluid passage in communication with the internal fluid passage of the valve body, and the second fluid conduit defining a second fluid passage in communication with the internal fluid passage of the valve body.

In some aspects at least one reinforcement rib may be attached to the valve body and configured to mitigate stress on the valve body due to pressurized fluid within the valve body, the reinforcement rib being attached to a front surface of the first side plate by a first weld connection, where a length of the first weld connection is less that a width of the first side plate.

According to another aspect of the present invention, the reinforcement rib is further attached to a front surface of the second side plate by a second weld connection, where a length of the second weld connection is less that a width of the second side plate.

According to another aspect of the present invention, the reinforcement rib is devoid of a weld connection with the first end plate, and the reinforcement rib is devoid of a weld connection with the second end plate.

According to another aspect of the present invention, a first side clearance between the reinforcement rib and a portion of the first side plate is provided, a second side clearance between the reinforcement rib and a portion of the second side plate is provided, and the first and second clearances define a respective first side slot and a second side slot.

According to another aspect of the present invention, a first end clearance between the reinforcement rib and the first end plate is provided, and a second end clearance between the reinforcement rib and the second end plate is provided, the first and second end clearances defining a respective first end slot and a second end slot.

According to another aspect of the present invention, a clearance is provided between the reinforcement rib and the valve body, where the clearance defines a generally U-shaped slot.

According to another aspect of the present invention, a plurality of reinforcement ribs are spaced based on optimization and stress areas. For instance, the ribs may be equally spaced apart longitudinally along the valve body.

According to another aspect of the present invention, the first end plate and the first side plate are connected by welding extending longitudinally along the valve body, and the first end plate and the second side plate are connected by welding extending longitudinally along the valve body.

According to another aspect of the present invention, the first conduit may include a first flange configured to attach to an inflow pipe, and the second conduit includes a second flange configured to attach to an outflow pipe.

According to another aspect of the present invention, the flanges may be welded directly to the body.

According to another aspect of the present invention, the first conduit is connected to the front surface of the first side plate by a first conduit weld connection extending along a circumference of the first conduit, and the second conduit is connected to the front surface of the second side plate by a second conduit weld connection extending along a circumference of the second conduit.

According to another aspect of the present invention, at least one first reinforcement fin may have a first side welded to the first conduit and a second side welded to the front surface of the first side plate, and at least one second reinforcement fin has a first side welded to the second conduit and a second side welded to the front surface of the second side plate, where the at least one first and second reinforcement fins are configured to relieve stress on the respective first and second conduits due to pressurized fluid within the first fluid passage and the second fluid passage. For instance, such reinforcement ribs may used especially in large size and/or high pressure valves.

According to another aspect of the present invention, a resilient seal member is coaxially disposed in the internal fluid passage of the valve body and extending between the valve body and the slab gate to form a barrier between the internal fluid passage and internal gate chamber.

According to another aspect of the present invention, the bonnet includes a flange portion overhanging a portion of the upper end of the valve body.

According to another aspect of the present invention, the bonnet is secured to the upper end of the valve body by one or more fasteners.

According to another aspect of the present invention, the bonnet includes an injector port configured to provide access to the interior of the valve body.

According to another aspect of the present invention, a packing retainer is removably attached to the bonnet, where the packing retainer is configured to slidably receive a valve stem.

According to another aspect of the present invention, a is yoke attached to the bonnet and surrounding the valve stem.

According to another aspect of the present invention, an actuator handle is connected to a gear assembly configured to move the slab gate between the open and closed positions.

According to another aspect of the present invention, the gate valve is devoid of a cupola.

According to another aspect of the present invention, a base plate is connected to a lower end of the valve body, the base plate configured to provide stability to the valve body when the valve body is in an upright standing position.

There has thus been outlined certain embodiments of the present invention in order that the detailed description thereof herein may be better understood, and in order that the present contribution to the art may be better appreciated. There are additional embodiments of the present invention that will be described below and which form the subject matter of the claims appended hereto.

In this respect, before explaining at least one aspect of the present invention in detail, it is to be understood that the gate valve assembly is not limited in its application to the details of construction and to the arrangements of the components set forth in the following description or illustrated in the drawings. The gate valve assembly is capable of aspects in addition to those described, and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this invention is based may readily be utilized as a basis for the designing of other structures, methods, and systems for carrying out the several purposes of the present invention. It is important, therefore, that the claims be regarded as including such equivalent constructions insofar as they do not depart from the spirit and scope of the invention.

### BRIEF DESCRIPTION OF THE DRAWINGS

In order that the present invention may be readily understood, aspects of the optimized gate valve assembly are illustrated by way of examples in the accompanying drawings, in which like parts are referred to with like reference numerals throughout.

FIG. 1 illustrates a perspective view of an optimized gate valve assembly according to an embodiment of the present invention.

FIG. 2 illustrates a side view of the gate valve assembly of FIG. 1.

FIG. 3 illustrates a front end view the gate valve assembly of FIG. 1.

FIG. 4 illustrates a cross-sectional view of the gate valve assembly taken along line 4-4 in FIG. 2.

FIG. 5 illustrates a cross-sectional view of the gate valve assembly taken along line 5-5 in FIG. 3.

FIG. 6 illustrates a partial front end view of the gate valve assembly according to an embodiment of the present invention.

FIG. 7 illustrates a partial side view of the gate valve assembly according to an embodiment of the present invention.

FIG. 8 illustrates a cross-sectional view of the gate valve assembly taken along line 8-8 in FIG. 2.

### DETAILED DESCRIPTION

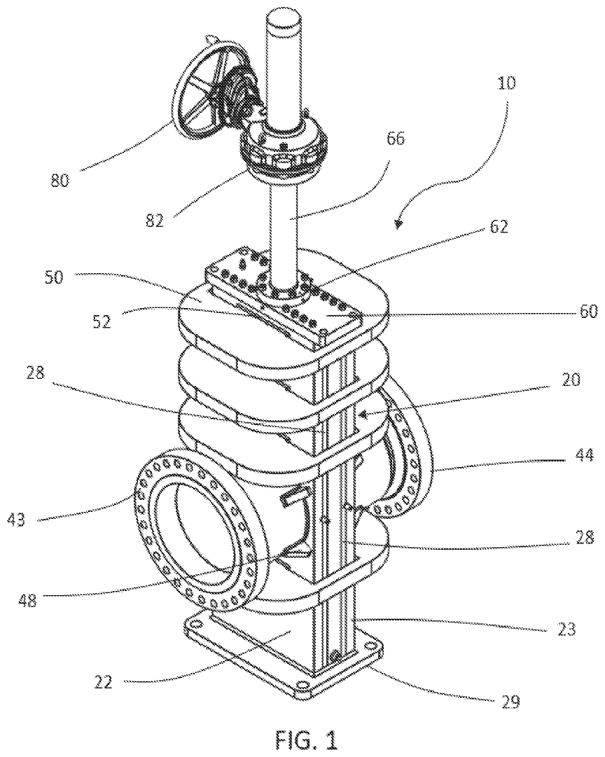

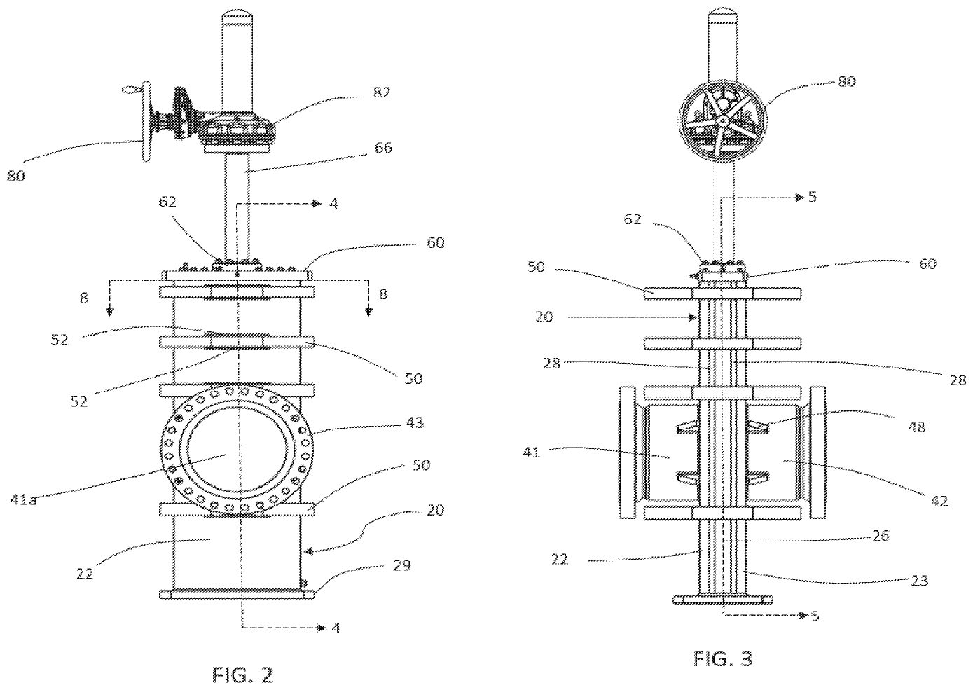

The present invention discloses an optimized gate valve assembly that is less costly and less time consuming to manufacture. An example of such an optimized gate valve assembly 10 in accordance with the present invention is depicted in FIGS. 1-5. The functionality of the optimized gate valve 10 may extend to applications including mainlines, pump stations, tank farm manifolds, and underground storage, among other installations. The optimized gate valve assembly 10 comprises a main fabricated valve body 20 which houses a slab gate 30 operable to move between an open position and a closed position. According to some aspects, the slab gate 30 may be in the form of a flat steel plate.

The main valve body 20 includes a first side plate 22 defining a first main wall of the valve body spaced apart from a second side plate 23 defining a second main wall of the valve body. The first side plate 22 has a front surface 22a and a rear surface 22b. Similarly, the second side plate 23 has a front surface 23a and a rear surface 23b. The first and second side plates 22, 23 are parallel to each other such that the rear surface 22b of the first side plate faces the rear surface 23b of the second side plate. Further, the first and second side plates 22, 23 have respective first and second openings 24, 25 that are aligned with each other. These first and second openings 24, 25 are generally circular shaped. In other implementations, the first and second openings may include an oval shape, a square shape, or a rectangular shape, among other shapes. The slab gate 30 includes a gate port 32 corresponding in shape and size to the first and second openings 24, 25 of the corresponding first and second side plates 22, 23 of the valve body.

The main valve body 20 also includes a first end plate 26 spaced apart from a second end plate 27, wherein the first and second end plates are parallel to each other. Each of the first and second end plates 26, 27 are sandwiched between opposite ends of the first and second side plates 22, 23 such that each end of the main valve body 20 remains substantially flush. In particular, a first side 26a of the first end plate 26 is welded to the rear surface 22b of the first side plate 22 by a connecting weld 28, and a second side 26b of the first end plate 26 is welded to the rear surface 23b of the second side plate 23 by another connecting weld 28. Similarly, a first side 27a of the second end plate 27 is welded to the rear surface 22b of the first side plate 22 by another connecting weld 28, and a second side 27b of the second end plate 27 is welded to the rear surface 23b of the second side plate 23 by another connecting weld 28. Each of the respective connecting welds 28 extends longitudinally along the length of the valve body 20 to fixedly secure the respective end plates 26, 27 flush against adjacent side plates 22, 23 such that each end of the valve body is substantially planar. The main valve body thus forms a pressure vessel in the shape of a substantially rectangular box having a rectangular cross-section. According to some aspects, both the side plates and the end plates of the valve body are each made of steel.

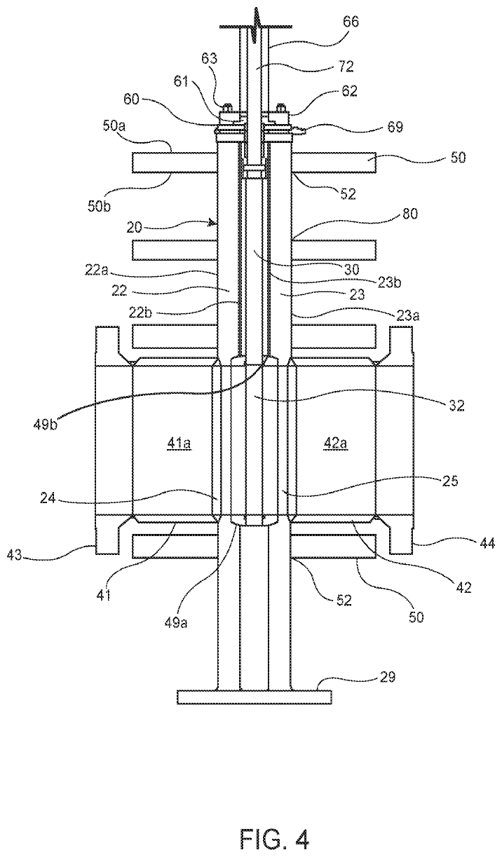

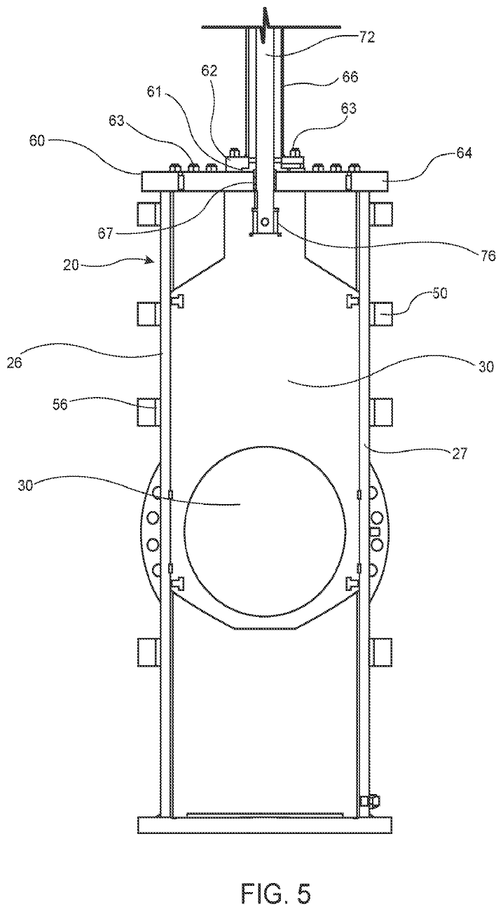

Referring to FIGS. 4 and 5, the gate valve assembly 10 further comprises a first cylindrical fluid conduit 41 defining a first passage 41a and a second cylindrical fluid conduit 42 defining a second passage 42a, where the first passage 41a is in fluid communication with the second passage 42a via the gate port 32 of the slab gate 30 when the gate valve assembly is in the open position. The first conduit 41 may be made from steel and welded along its circumference to the front surface 22a of the first side plate 22 surrounding the first opening 24, thus forming a first circular weld connection 45. The second conduit 42 may be made from steel and welded along its circumference to the front surface 23a of the second side plate 23 surrounding the second opening 25, thus forming a second circular weld connection 46.

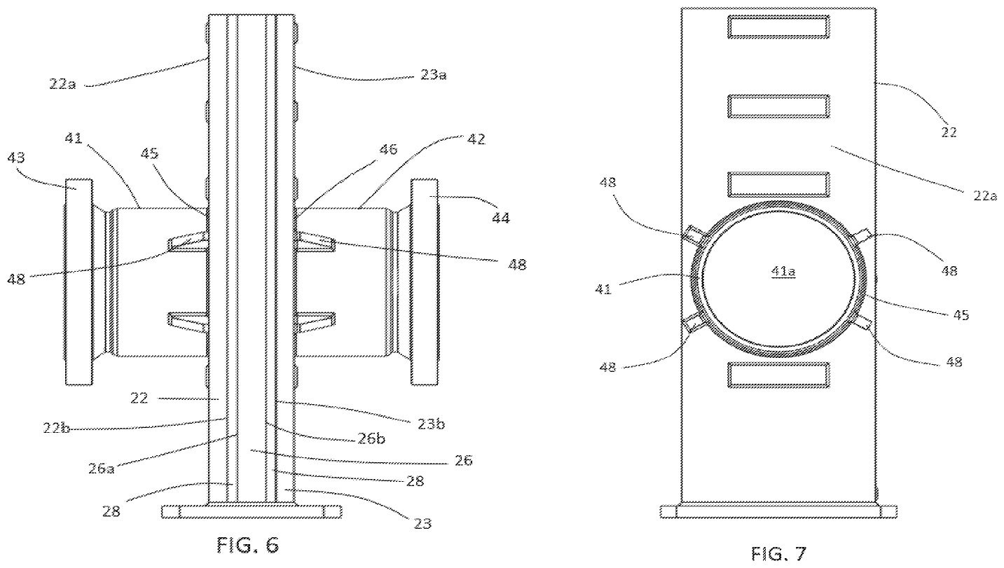

According to some aspects, one or more reinforcement fins 48 may be welded to the first fluid conduit 41 and the front surface 22a of the first side plate 22. Similarly, one or more of the reinforcement fins 48 may be welded to the second fluid conduit 42 and the front surface 23a of the second side plate 23. Each reinforcement fin 48 provides additional stabilizing strength to the fluid conduits attached to the valve body. In some implementation, a plurality of the reinforcement fins 48 may be annularly spaced apart on each of the first and second fluid conduits 41, 42 to ensure an equal distribution of stress on the respective fluid conduit caused from the pressurized fluid flow through the valve body. For instance, the implementation shown in FIGS. 6 and 7 depicts four reinforcement fins 48 spaced apart along the circumference of each fluid conduit 41, 42.

Each reinforcement fin 48 has a generally triangular shape having three sides, wherein a first side of the fin abuts and is welded to a respective fluid conduit, and a second side of the fin abuts and is welded to the front surface of the corresponding side plate. As such, the overall amount of welding required to securely attach each reinforcement fin 48 to a corresponding conduit and side plate is much less than the amount of welding that is typically required to attach a conventional transition piece between a conduit and a valve body. Accordingly, the use of such reinforcement fins reduces the related manufacturing time and associated manufacturing expenses, while advantageously providing sufficient structural stability to the fluid conduit to protect against stress resulting from the pressurized fluid flow through the gate valve.

The gate valve assembly 10 is further configured to connect to a piping system. The first conduit 41 includes an annular bolting flange 43 configured to attach to a first pipe, such as an inflow pipe. The second conduit 42 includes an annular bolting flange 44 configured to attach to a second pipe, such as an outflow pipe. The port 32 of the slab gate 30 is adapted to register in fluid communication with the first and second passages 41a, 42a through the first and second fluid conduits 41, 42 when the gate valve assembly is in the open position. The slab gate 30 is moved downwardly to bring it to the closed position, in which fluid communication between the port 32 and the first and second fluid conduits is not established. In some implementations, a pair of resilient seat rings 49a, 49b, such as an elastomeric O-ring or washer, may be interposed between the inner ends of the respective top and bottom portions of the first and second fluid conduits and the front and rear faces of the slab gate.

The movable slab gate 30 allows pipeline pressure to enhance sealing in both high and low pressure conditions, and further allows positive shut-off control to efficiently isolate sections of pipeline utilizing natural force-of-line pressure to create a dynamic downstream seal in high pressure differential applications. To brace the side plates 22, 23 and the end plates 26, 27 against such internal pressure, one or more reinforcement ribs 50 may be attached to the main valve body 20. The reinforcement ribs 50 give the valve body 20 the necessary strength to support the line and gate loads at a location where such strength is needed. For instance, the first and second side plates 22, 23 may be reinforced against outward bulging by means of the reinforcement ribs 50 which surround the main valve body 20. The number, size, and positioning of each reinforcement rib depends largely upon the operating pressures for which the valve body is designed. For instance, the gate valve assembly depicted in the present figures includes three reinforcement ribs 50 provided above the first and second fluid conduits 41, 42, and a single reinforcement rib provided below the first and second fluid conduits. More or less reinforcement ribs may be provided in other implementations.

Each reinforcement rib 50 has a generally rectangular-shaped opening to accommodate the main valve body 20. More particularly, each rib 50 is configured to surround the main valve body 20 such that each rib extends laterally away from both the first and second side plates as well as the first and second end plates 26, 27. In some aspects, a length of a portion of the reinforcement rib extending away from one of the side plates is greater than a length of a portion of the rib extending away from one of the end plates. Each reinforcement rib 50 is welded to a corresponding portion of the first and second side plates 22, 23 of the body by a respective weld connection 52. In particular, a first inner edge at the top surface 50a of each reinforcement rib 50 is welded to the front surface 22a of the first side plate 22 thus forming a respective weld connection, and a second inner edge at the top surface 50a of each reinforcement rib 50 is welded to the front surface 23a of the second side plate 23 thus forming a respective weld connection. Similarly, a first inner edge at the bottom surface 50b of each reinforcement rib 50 is welded to the front surface 22a of the first side plate 22 thus forming a respective weld connection, and a second inner edge at the bottom surface 50b of each reinforcement rib 50 is welded to the front surface 23a of the second side plate 23 forming a respective weld connection.

Accordingly, by this arrangement, the weld connections are made shorter than the width of the side plates of the valve body. As such, each reinforcement rib 50 is not welded to the first and second end plates 26, 27. Rather, a small clearance or gap forming a slot 56 is provided between each reinforcement rib and each of the first and second end plates 26, 27. Stated another way, the valve body is devoid of welding between the reinforcement ribs and the end plates. Additionally, the weld connections 52 terminate short of the longitudinal corners of the main valve body, thus leaving the reinforcement ribs 50 free of the end portions of the valve body. The length of the reinforcement ribs is such as to sufficiently transmit stress away from the side plates of the body.

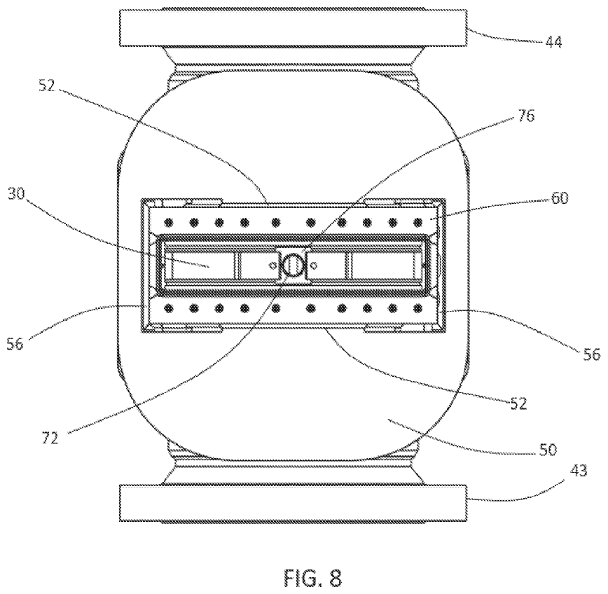

The length of each weld connection 52 extending along the corresponding portions of each side plate is less than the width of each respective side plate. As shown in FIG. 8, each slot 56 therefore extends around the respective end plates and partially along the adjacent side plates to minimize concentration of stresses, while also providing adequate strength for the side plates to withstand the forces exerted by fluid pressure within the main valve body. As a result, the amount of welding required to secure the reinforcement ribs to the main valve body is substantially reduced, thus decreasing the related manufacturing time and associated manufacturing costs, such as labor costs. Such a limited length for the direct weld connections between the reinforcement ribs and the side plates is desirable for larger sized valves in which a long weld connection would be subjected to severe shear stresses.

The manner in which the reinforcement ribs 50 are welded to the main valve body 20 helps avoid unfavorable concentration of stresses on the body, particularly where the reinforcement ribs are separated from the main body by the slots 56. Furthermore, the slots also serve to reduce the shear and tension stresses on the adjacent weld connections. Thus, a greater load can be carried for a reinforcement rib of a particular size and tensile strength. This furthermore helps the main body effectively resist bulging of the side plates, as well as the front plates, since the amount of stress applied in the region of the inner corners of the reinforcement ribs and the corresponding slots is reduced when a given load is applied.

The main valve body is therefore also able to withstand high internal pressures without utilizing excessive wall thicknesses. Consequently, the side plates and the end plates of the valve body may be made thinner than those of traditional gate valve assemblies, thus reducing the amount of raw material and the amount of welding needed for fabrication, and further decreasing the associated manufacturing costs. Additionally, the side plates 22, 23 of the valve body are braced against outward bulging by the reinforcement ribs 50 when the body is subjected to internal pressure, and stresses applied to these ribs are not transmitted to other parts of the main body. This optimized construction is advantageous for gate valves of various sizes, including large size and or higher class gate valves where working pressures are particularly large.

A bonnet 60 is removably attached to an upper end of the main valve body 20. As such, the top entry of the main valve body is designed for in-line maintenance of the valve assembly. A lower end of the main valve body is welded to a base plate 29 dimensioned to provide stability to the valve body when the body is in an upright standing position. The bonnet 60 includes a pair of flange portions 64 that overhang respective ends of the main valve body to provide increased distribution of stress at the upper end of the main valve body. The bonnet 60 is secured to the upper end of the main valve body 20 by one or more fasteners 63, such as threaded bolts.

A packing retainer 61 may be secured to the bonnet 60 via additional fasteners 63. A yoke or pipe 66 surrounds a valve stem 72, and a bottom end 62 of the yoke 66 is seated upon the packing retainer 61 and bolted to the bonnet 60 by one or more of the fasteners 63. According to some aspects, the packing retainer may allow the yoke to be removed while the valve is under pressure, thus providing safety to the operator. In this arrangement, the gate valve assembly does not include a cupola. One or more resilient seal members 67, such as a stem packing or washer, may be provided between the bonnet 60 and the valve stem 72 to prevent fluid leakage from the main valve body 20. Further, the seal member 67 may be held within a corresponding recess of the bonnet 60.

The bonnet flange may include a packing injector port 69 to provide access inside the packing cavity. The valve stem 72 is connected to a recessed end of the slab gate 30 via a connector 76, such as a complementary fork and pin arrangement. Moving the slab gate between the open and closed positions is accomplished by turning an operator handle 80, such as a hand wheel, that is connected to a gear assembly 82 to correspondingly move the valve stem 72 through the interior of the valve body via the bonnet assembly 60. As the valve stem moves up and down, so does the attached slab gate. In some implementations, the valve stem 72 may be constructed as a two-piece stem to allow for ease of repair and replacement.

While an optimized gate valve assembly has been described in terms of what may be considered to be specific aspects, the present invention is not limited to the disclosed aspects. Additional modifications and improvements to the present invention may be apparent to those skilled in the art. Moreover, the many features and advantages of the disclosure are apparent from the detailed specification, and thus, it is intended by the appended claims to cover all such features and advantages of the present invention which fall within the spirit and scope of the disclosure. Further, it is not desired to limit the disclosure to the exact construction and operation illustrated and described, and accordingly, all suitable modifications and equivalents may be resorted to, falling within the scope of the disclosure. The present disclosure should therefore be considered as illustrative and not restrictive. As such, this disclosure is intended to cover various modifications and similar arrangements included within the spirit and scope of the claims, which should be accorded their broadest interpretation so as to encompass all such modifications and similar structures.

1. A gate valve, comprising:
a valve body including a first side plate, a second side plate, a first end plate, and a second end plate, the first side plate being spaced apart from the second side plate and the first end plate being spaced apart from the second end plate to define an internal fluid passage and an internal gate chamber extending transverse to the internal fluid passage;
a slab gate disposed in the internal gate chamber, the slab gate operable to move within the internal gate chamber between an open position allowing fluid flow through the fluid passage and a closed position obstructing fluid flow through the internal fluid passage;
a bonnet removably attached to an upper end of the valve body; and
a first fluid conduit connected to the first side plate and a second fluid conduit connected to the second side plate, the first fluid conduit defining a first fluid passage in communication with the internal fluid passage of the valve body, and the second fluid conduit defining a second fluid passage in communication with the internal fluid passage of the valve body.

2. The gate valve of claim 1, further comprising an reinforcement rib attached to the valve body and configured to mitigate stress on the valve body due to pressurized fluid within the valve body, the reinforcement rib being attached to a front surface of the first side plate by a first weld connection, where a length of the first weld connection is less that a width of the first side plate, and wherein the reinforcement rib is further attached to a front surface of the second side plate by a second weld connection, where a length of the second weld connection is less than a width of the second side plate.

3. The gate valve according to claim 2, wherein the reinforcement rib is devoid of a weld connection with the first end plate, and the reinforcement rib is devoid of a weld connection with the second end plate.

4. The gate valve of claim 2, further comprising a first side clearance between the reinforcement rib and a portion of the first side plate, a second side clearance between the reinforcement rib and a portion of the second side plate, the first and second clearances defining a respective first side slot and a second side slot.

5. The gate valve of claim 2, further comprising a first end clearance between the reinforcement rib and the first end plate, and a second end clearance between the reinforcement rib and the second end plate, the first and second end clearances defining a respective first end slot and a second end slot.

6. The gate valve of claim 2, further comprising a clearance between the reinforcement rib and the valve body, where the clearance defines a generally U-shaped slot.

7. The gate valve of claim 2, further comprising a plurality of reinforcement ribs spaced apart longitudinally along the valve body.

8. The gate valve of claim 1, wherein the first end plate and the first side plate are connected by welding extending longitudinally along the valve body, and the first end plate and the second side plate are connected by welding extending longitudinally along the valve body.

9. The gate valve of claim 1, wherein the first conduit includes a first flange configured to attach to an inflow pipe, and the second conduit includes a second flange configured to attach to an outflow pipe.

10. The gate valve of claim 1, wherein the first conduit is connected to the front surface of the first side plate by a first conduit weld connection extending along a circumference of the first conduit, and the second conduit is connected to the front surface of the second side plate by a second conduit weld connection extending along a circumference of the second conduit.

11. The gate valve of claim 1, further comprising at least one first reinforcement fin having a first side welded to the first conduit and a second side welded to the front surface of the first side plate, and at least one second reinforcement fin having a first side welded to the second conduit and a second side welded to the front surface of the second side plate, where the at least one first and second reinforcement fins are configured to relieve stress on the respective first and second conduits due to pressurized fluid within the first fluid passage and the second fluid passage.

12. The gate valve of claim 1, further comprising a resilient seal member coaxially disposed in the internal fluid passage of the valve body and extending between the valve body and the slab gate to form a barrier between the internal fluid passage and internal gate chamber.

13. gate valve of claim 1, wherein the bonnet includes a flange portion overhanging a portion of the upper end of the valve body.

14. The gate valve of claim 1, wherein the bonnet is secured to the upper end of the valve body by one or more fasteners.

15. The gate valve of claim 1, wherein the bonnet includes an injector port configured to provide access toa stem packing system.

16. The gate valve of claim 1, further comprising a packing retainer removably attached to the bonnet, where the packing retainer is configured to slidably receive a valve stem.

17. The gate valve according to claim 16, further comprising a yoke attached to the bonnet and surrounding the packing retainer and the valve stem.

18. The gate valve of claim 1, further comprising an actuator handle connected to a gear assembly configured to move the slab gate between the open and closed positions.

19. The gate valve of claim 1, wherein the gate valve is devoid of a cupola.

20. The gate valve of claim 1, further comprising a base plate connected to a lower end of the valve body, the base plate configured to provide stability to the valve body when the valve body is in an upright standing position.
